(19) United States
(12) Patent Application Publication
(10) Pub. No.: US 2015/0323762 A1
(43) Pub. Date: Nov. 12, 2015

(54) IMAGING DEVICE

(71) Applicant: Sony Corporation, Tokyo (JP)

(72) Inventors: Koichi Sadatsuki, Tokyo (JP); Osamu Toyoshima, Tokyo (JP); Kazuhiro Nishida, Tokyo (JP)

(21) Appl. No.: 14/671,004

(22) Filed: Mar. 27, 2015

(30) Foreign Application Priority Data
May 8, 2014 (JP) 2014-097124

(51) Int. Cl. G02B 13/00; H04N 5/232; H04N 5/225; G03B 13/34

(52) U.S. Cl. CPC G02B 13/009; G03B 13/34; H04N 5/23296; H04N 5/2254

(57) ABSTRACT

There is provided an imaging device including an outer case in which a photographic lens is disposed inside. The outer case includes a cylindrical portion in which an external shape of a cross-section perpendicular to an optical axis of the photographic lens is formed into a substantially circular shape, and a rolling prevention portion provided to protrude outside the cylindrical portion in a direction perpendicular to the optical axis. The rolling prevention portion is provided on a lower surface side of the cylindrical portion. A central portion of the rolling prevention portion in a horizontal direction is positioned off to left or right of a central portion of the cylindrical portion in the horizontal direction.

### CROSS REFERENCE TO RELATED APPLICATIONS

This application claims the benefit of Japanese Priority Patent Application JP 2014-097124 filed May 8, 2014, the entire contents of which are incorporated herein by reference.

### BACKGROUND

The present technology relates to a technical field of an imaging device in which an outer case is provided with a cylindrical portion in which an external shape of a cross-section perpendicular to an optical axis of a photographic lens is formed into a substantially circular shape.

There are devices having different functions, one device of which is detachably attached to the other device. As such devices of which one device is detachably attached to the other device, for example, there are an interchangeable lens having a zoom function and a camera device body having an imaging function.

Also, there are devices having different functions, one device of which is detachably attached to the other device through an adapter. As such an example, an interchangeable lens is detachably attachable to a camera device body through an adapter (see, for example, JP 2013-92556A).

As a method of attaching an adapter to a camera device body, JP 2013-92556A describes a method of engaging an engagement unit of the adapter with an engagement unit of the camera device body by rotating the entire adapter with respect to the camera device body.

On the other hand, in recent years, with the advance of communication technologies such as a wireless local area network (LAN), for example, development such as displaying an image acquired by an imaging device on a display panel (display) of a display device is progressing.

### SUMMARY

By the way, in the imaging device that can perform an imaging operation in conjunction with the display device, it is desirable to improve usability ensuring good storage property during unuse and good grasping property during photographing.

Therefore, the imaging device according to embodiments of the present technology is directed to improve usability.

First, according to an embodiment of the present disclosure, there is provided an imaging device including an outer case in which a photographic lens is disposed inside. The outer case includes a cylindrical portion in which an external shape of a cross-section perpendicular to an optical axis of the photographic lens is formed into a substantially circular shape, and a rolling prevention portion provided to protrude outside the cylindrical portion in a direction perpendicular to the optical axis. The rolling prevention portion is provided on a lower surface side of the cylindrical portion. A central portion of the rolling prevention portion in a horizontal direction is positioned off to left or right of a central portion of the cylindrical portion in the horizontal direction.

Therefore, the rolling prevention portion prevents the imaging device from rolling, and photographing can be performed by grasping the rolling prevention portion during photographing.

Second, according to another embodiment of the present disclosure, the central portion of the rolling prevention portion in the horizontal direction may be positioned off to the left of the cylindrical portion.

Therefore, a left hand is put on the rolling prevention portion since a photographer tends to perform photograph with his left hand grasping the imaging device.

Third, according to another embodiment of the present disclosure, an operation unit may be disposed on the rolling prevention portion.

Therefore, when the imaging device is grasped, a finger is naturally put on the rolling prevention portion protruding from the cylindrical portion.

Fourth, according to another embodiment of the present disclosure, a shooting button configured to capture a subject may be provided as the operation unit.

Therefore, the shooting button can be easily pressed by moving the finger put on the rolling prevention portion protruding from the cylindrical portion.

Fifth, according to another embodiment of the present disclosure, a zoom knob configured to change photographic magnification may be provided as the operation unit.

Therefore, the zoom knob can be easily operated by moving the finger put on the rolling prevention portion protruding from the cylindrical portion.

Sixth, according to another embodiment of the present disclosure, the zoom knob may be operated by vertical movement.

Therefore, the zoom knob can be easily operated by moving the finger in the vertical direction in a state of being put on the rolling prevention portion.

Seventh, according to another embodiment of the present disclosure, at least a part of a drive mechanism including a drive motor may be disposed inside the rolling prevention portion.

Therefore, the inside of the rolling prevention portion having a function of preventing the imaging device from rolling is used as a disposition space for the drive mechanism.

Eighth, according to another embodiment of the present disclosure, at least a part of an outer surface of the rolling prevention portion may have a curved shape.

Therefore, a palm is put on a curved-shape part of the rolling prevention portion in a state where the palm is put on a position over a side surface from a lower surface of the outer case.

Ninth, according to another embodiment of the present disclosure, the cylindrical portion and the rolling prevention portion may be formed of different members. The cylindrical portion and the rolling prevention portion may be coupled.

Therefore, each of the cylindrical portion and the rolling prevention portion can be easily formed to have a predetermined shape.

Tenth, according to another embodiment of the present disclosure, a surface of the cylindrical portion and a surface of the rolling prevention portion may have different colors.

Therefore, the cylindrical portion can be accentuated more than the rolling prevention portion.

Eleventh, according to another embodiment of the present disclosure, the rolling prevention portion may have a glossy front surface.

Therefore, color of a placement surface can be reflected in the glossy surface when the imaging device is placed on the placement surface such as a desk or a table.

Twelfth, according to another embodiment of the present disclosure, a zoom drive mechanism may be disposed inside the cylindrical portion, the zoom drive mechanism including a zoom lens and a zoom motor configured to move the zoom lens in the optical axis direction so as to change photographic magnification. The zoom drive mechanism may be disposed along an inner periphery of the cylindrical portion.

Therefore, the zoom drive mechanism is disposed at an outer periphery side inside the cylindrical portion.

Thirteenth, according to another embodiment of the present disclosure, the zoom motor may be disposed in a state where a motor axis of the zoom motor is inclined vertically and horizontally.

Therefore, a position where the zoom motor is disposed has a high degree of freedom.

Fourteenth, according to another embodiment of the present disclosure, the zoom drive mechanism may be disposed on a rear side of the zoom lens.

Therefore, the zoom drive mechanism is not positioned at an outer periphery side of the zoom lens.

According to the embodiments of the present technology, the rolling prevention portion prevents the imaging device from rolling, and photographing can be performed by grasping the rolling prevention portion during photographing. Accordingly, good storage property during unuse and good grasping property during photographing are ensured, and it is possible to improve the usability of the imaging device.

Also, the effects described herein are only for illustrative purposes and are not limited, and there may be other effects.

### BRIEF DESCRIPTION OF THE DRAWINGS

FIG. 1 shows an imaging device according to an embodiment of the present technology together with FIGS. 2 to 16 and is a perspective view showing a state in which an imaging device is mounted on a display device through an adapter;

FIG. 2 is a perspective view showing a state in which the imaging device is mounted on the display device through the adapter, when viewed in a direction different from a direction of FIG. 1;

FIG. 3 is an enlarged perspective view of an imaging device;

FIG. 4 is an enlarged front view of the imaging device;

FIG. 5 is an enlarged rear view of the imaging device;

FIG. 6 is an enlarged plan view of the imaging device;

FIG. 7 is an enlarged bottom view of the imaging device;

FIG. 8 is an enlarged side view of one side of the imaging device;

FIG. 9 is an enlarged side view of the other side of the imaging device;

FIG. 10 is an enlarged perspective view of the imaging device in a state in which an inner cylinder portion is drawn out forward;

FIG. 11 is a schematic enlarged rear view showing an imaging structure and an outer case;

FIG. 12 is a schematic enlarged perspective view showing the imaging structure;

FIG. 13 is a perspective view showing an example of a use mode of the imaging device;

FIG. 14 is a perspective view showing another example of a use mode of the imaging device;

FIG. 15 is a side view showing another example of a use mode of the imaging device; and

FIG. 16 is a block diagram of the imaging device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the following description, it is assumed that a front-rear direction, a vertical direction, and a horizontal direction are based on a direction viewed from a photographer at the time of photographing of the imaging device. Therefore, a subject side is the front and a photographer side is the rear. Also, note that the front-rear direction, the vertical direction, and the horizontal direction described below are only for convenience of explanation and the embodiments of the present technology are not limited to these directions.

[Relationship among Imaging Device, Adapter, and Display Device]

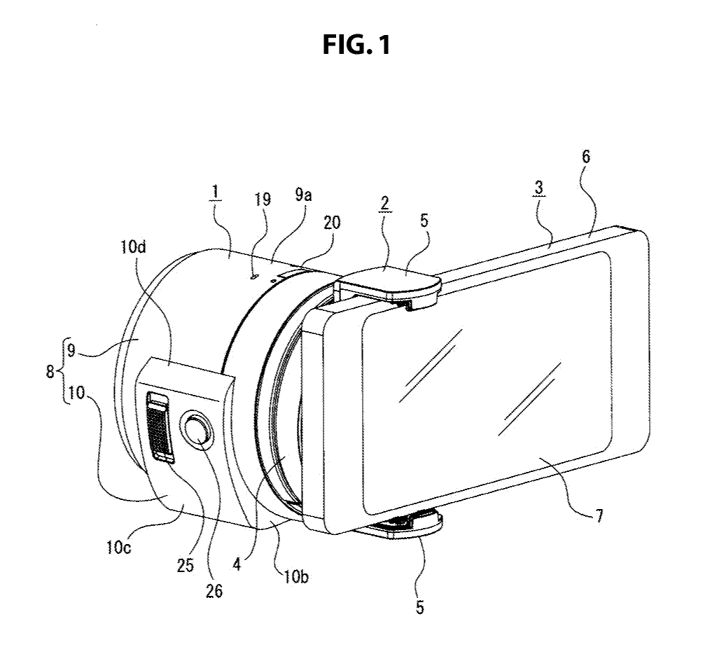

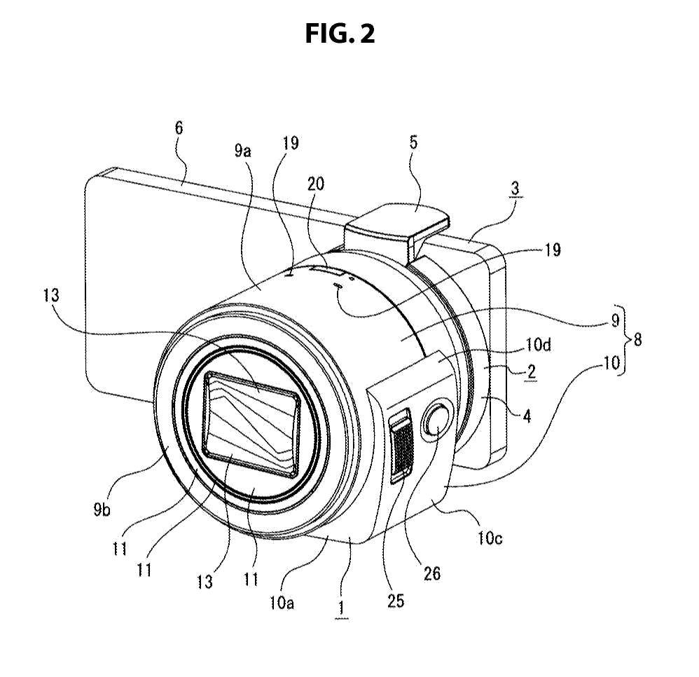

First, a relationship among an imaging device 1, an adapter 2 and a display device 3 will be briefly described (see FIGS. 1 and 2). The adapter 2 and the display device may be used together with an imaging device 1.

The adapter 2 is detachably attached to a rear surface of the imaging device 1. The adapter 2 is detachably attached to the display device 3.

The adapter 2 includes necessary components disposed inside and outside a base body 4. An external shape of the base body 4 is formed to have a circular shape, and the base body 4 is formed to have a flat shape whose thickness of a front-rear direction is thin. In the base body 4, a pair of accommodation concave portions (not shown) is formed on opposite sides, with a central portion being interposed therebetween. On the front side of the base body 4, a pair of coupling holes (not shown) is formed to be spaced apart in a circumferential direction. On the front side of the base body 4, a locked hole (not shown) opened forward is formed.

The adapter 2 is provided with a pair of mounted bodies 5 and 5 that are rotatable with respect to the base body 4. The mounted bodies 5 and 5 are rotatable at positions of opposite sides, with the central portion of the base body 4 being interposed therebetween. Each of the mounted bodies 5 and 5 is rotatable between an accommodation position where each of the mounted bodies 5 and 5 is accommodated in the accommodation concave portion of the base body 4 and a drawn-out position where each of the mounted bodies 5 and 5 is drawn out from the accommodation concave portion.

The mounted bodies 5 and 5 are movable such that one of the mounted bodies 5 and 5 is movable with respect to the other in a contacting/separating direction (vertical direction), and one of the mounted bodies 5 and 5 is biased in a direction of approaching the other by a spring (not shown).

The mounted bodies 5 and 5 are mounted on the display device 3 such that the display device 3 is interposed between the mounted bodies 5 and 5 in a vertical direction in a state in which the mounted bodies 5 and 5 are rotated to the drawn-out position. At this time, since one of the mounted bodies 5 and 5 is biased in a direction of approaching the other, the stable mounting state of the adapter 2 with respect to the display device 3 is ensured, with the display device 3 being interposed therebetween in the vertical direction.

The display device 3 is, for example, a mobile phone such as a smartphone. However, the display device 3 is not limited to the mobile phone, and the display device 3 may be any device as long as the device has a display function. For example, the display device 3 may be a mobile terminal, a television system, or the like.

The display device 3 includes necessary components disposed inside and outside a housing 6. The housing 6, for example, is formed to have a substantially rectangular case shape, and a display panel 7 is provided on one surface (rear surface) of the housing 6. The display panel 7 executes a predetermined function by performing a contact operation on each predetermined position of the display panel 7 that is a touch panel.

### [Configuration of Imaging Device]

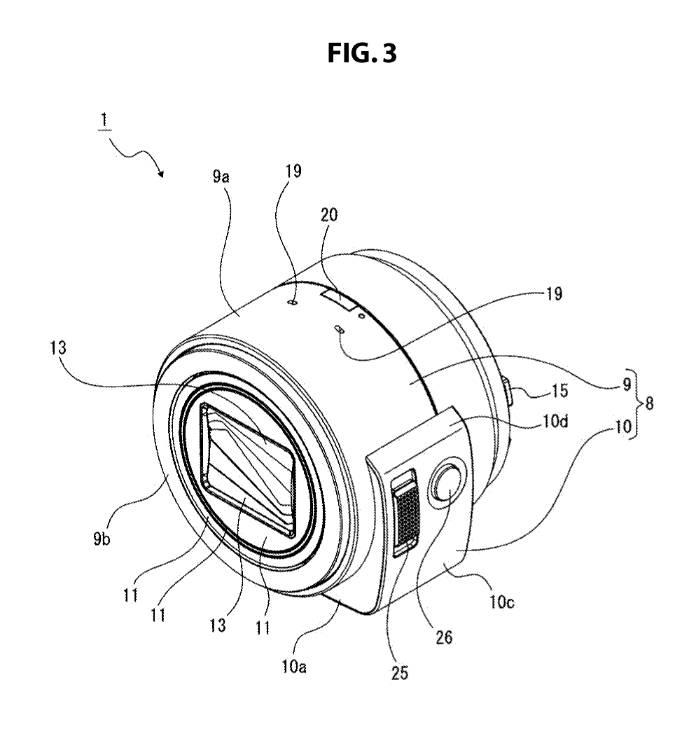

Next, the configuration of the imaging device 1 will be described (see FIGS. 3 to 10).

The imaging device 1 includes necessary components disposed inside and outside an outer case 8. The outer case 8 includes an outer cylinder portion 9 and a rolling prevention portion 10. In the inside of the outer cylinder portion 9, a plurality of lens groups lined in the front-rear direction (optical axis direction) and an image sensor (not shown) positioned at the rear side of the lens groups are disposed. In the imaging device 1, light captured through the lens groups is photoelectrically converted by the image sensor.

The outer cylinder portion 9 includes a cylindrical portion 9a formed to have a substantially cylindrical shape penetrating back and forth, an overhanging portion 9b overhanging inwardly from a front end part of the cylindrical portion 9a, and a rear surface portion 9c closing the cylindrical portion 9a from behind. In the cylindrical portion 9a, an external shape of a cross-section perpendicular to the front-rear direction that is an optical axis direction of the lens groups is formed to have a substantially circular shape.

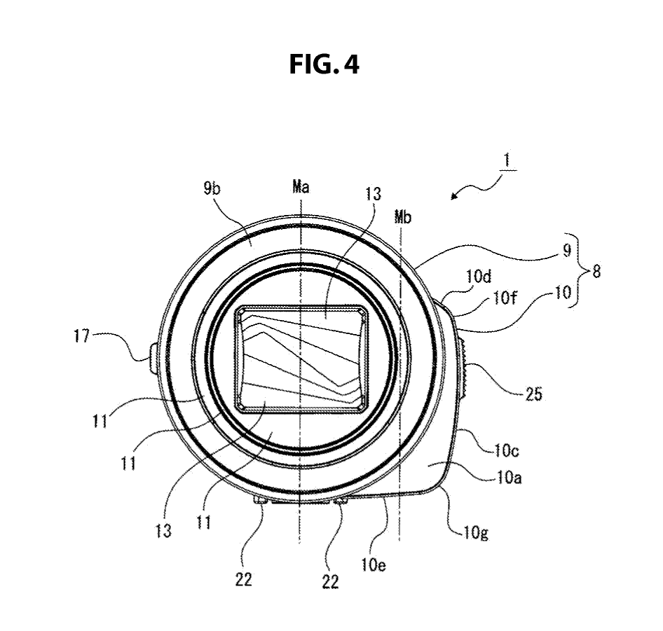

At the lower surface side of the cylindrical portion 9a, the rolling prevention portion 10 is provided to protrude outside the cylindrical portion 9a in a direction perpendicular to the optical axis direction of the lens groups. As shown in FIG. 4, a central portion (central line) Mb of the rolling prevention portion 10 in a horizontal direction is positioned off to left or right, for example, to the left, of a central portion (central line) Ma of the cylindrical portion 9a in the horizontal direction. The central line Ma intersects with the optical axis of the lens groups.

The outer cylinder portion 9 is formed of a member different from the rolling prevention portion 10. For example, the entirety of the rolling prevention portion 10 is positioned at the left side of the central portion Ma, and the outer surface includes a front surface 10a, a rear surface 10b, a side surface 10c, and a top surface 10d, and a bottom surface 10e. In the inside of the rolling prevention portion 10, a space communicating with a space inside the outer cylinder portion 9 is formed.

The rolling prevention portion 10 has a function of preventing the imaging device 1 from rolling when the imaging device 1 is placed on a placement surface such as a desk or a table, and the rolling prevention portion 10 can prevent damage or malfunction due to the falling or the like of the imaging device 1. In particular, the imaging device 1 is configured such that the outer surface of the cylindrical portion 9a is a circumferential surface shape, and the rolling prevention portion 10 is useful to prevent damage or malfunction due to the falling or the like.

The side surface 10c faces substantially the left, and is formed to have an extremely gentle outward convex curved shape. The bottom surface 10e faces substantially the bottom, and is formed downward to have an extremely gentle convex curved shape. A continuous part between the side surface 10c and the top surface 10d is formed as an upper curved-surface continuous part 10f having a curved shape. A continuous part between the side surface 10c and the bottom surface 10e is formed as a lower curved-surface continuous part 10g having a curved shape. The bottom surface 10e is positioned at a substantially same height as the lower end of the cylindrical portion 9a.

With regard to the outer case 8, the outer cylinder portion 9 and the rolling prevention portion 10 are formed of different members, and the outer cylinder portion 9 and the rolling prevention portion 10 are coupled.

As described above, the outer cylinder portion 9 and the rolling prevention portion 10 are formed of different members. Accordingly, it becomes easier to form each of the outer cylinder portion 9 and the rolling prevention portion 10 into a predetermined shape, and a good workability of the outer case 8 can be ensured.

In addition, processes such as paint performed on the outer cylinder portion 9 and the rolling prevention portion 10 can be separately performed, and the different processes can be performed on them. Accordingly, a design for emphasizing the outer cylinder portion 9 rather than the rolling prevention portion 10 can be achieved, and a design property of the entire imaging device 1 can be improved.

In addition, since the surface of the outer cylinder portion 9 and the surface of the rolling prevention portion 10 are differently colored, the outer cylinder portion 9 can be accentuated more than the rolling prevention portion 10. Accordingly, the outer cylinder portion 9 is accentuated, and the shape of the outer cylinder portion 9 is clearly shown.

In addition, by giving a glossy color or attaching a glossy sheet or a glossy panel to the front surface 10a of the rolling prevention portion 10, color of the placement surface can be reflected in the glossy surface when the imaging device 1 is placed on the placement surface such as a desk or a table. That is, the rolling prevention portion 10 looks like to be assimilated into the placement surface, and the outer cylinder portion 9 can be designed to be emphasized rather than the rolling prevention portion 10. Accordingly the design property of the entire imaging device 1 can be improved.

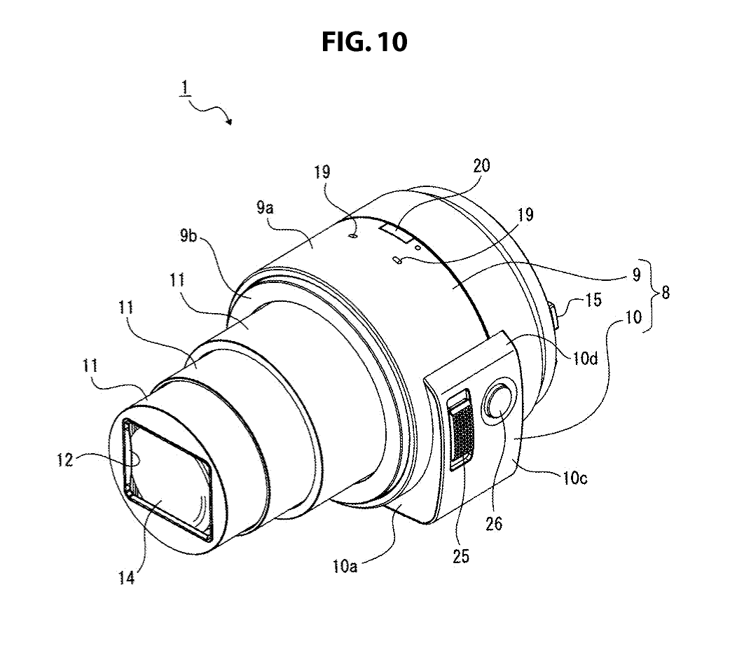

In the inside of the outer cylinder portion 9, inner cylinder portions 11 and 11 that are movable in the front-rear direction are supported (see FIGS. 3 and 10). The imaging device 1 becomes a photographing state when the inner cylinder portions 11 and 11 are drawn forward with respect to the outer cylinder portion 9 (see FIG. 10), and becomes a retracted state when the inner cylinder portions 11 and 11 drawn forward are retracted rearward and accommodated in the inside of the outer cylinder portion 9 (see FIG. 3).

A light transmission hole 12 having a substantially rectangular shape is formed at a front surface part of the innermost inner cylinder portion 11 (see FIG. 10). Lens barriers 13 and 13 are openably and closably supported at the front surface part of the innermost inner cylinder portion 11. In a case of the retracted state, the lens barriers 13 and 13 are closed by an opening/closing mechanism (not shown). In a case of the photographing state, the lens barriers 13 and 13 are opened by the opening/closing mechanism. That is, in the retracted state, the light transmission hole 12 of the inner cylinder portion 11 is closed by the lens barriers 13 and 13 (see FIG. 3), and in the photographing state, the light transmission hole 12 is opened by the lens barriers 13 and 13 (see FIG. 10).

In the inside of the imaging device 1, the plurality of lens groups including the photographic lens 14 positioned at the most front side are disposed to be spaced apart in the optical axis direction. When the light transmission hole 12 is opened by the lens barriers 13 and 13, light is incident from an outside on the photographic lens 14.

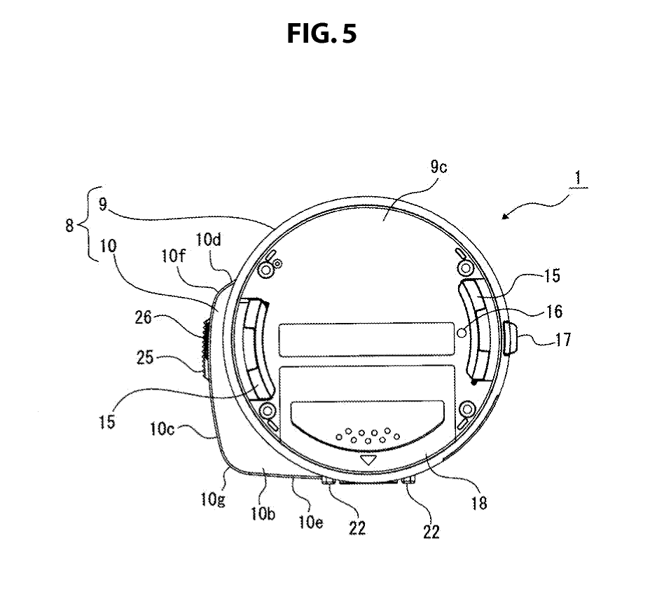

In the rear surface portion 9c of the outer cylinder portion 9, coupling protrusion portions 15 and 15 protruding rearward are provided on an outer peripheral part to be spaced apart in a circumferential direction (see FIG. 5).

In the rear surface portion 9c, a lock pin 16 is supported movably in a front-rear direction in the vicinity of the coupling protrusion portion 15. The lock pin 16 is biased backward by a spring (not shown).

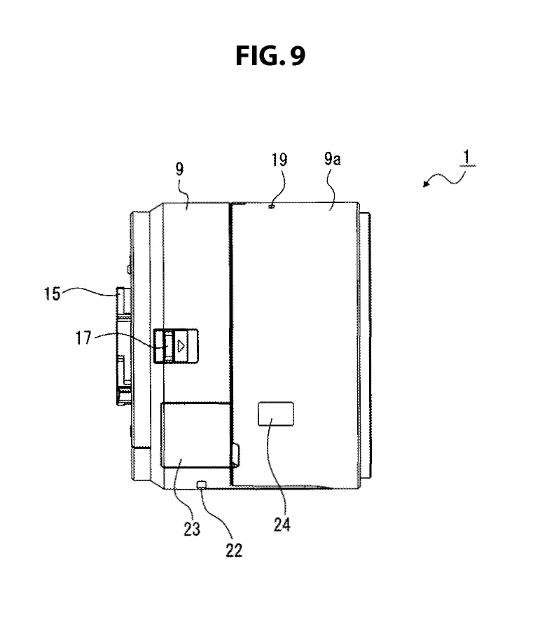

In a rear end part of the cylindrical portion 9a of the outer cylinder portion 9, a lock release lever 17 is disposed (see FIG. 9). By operating the lock release lever 17, the lock pin 16 is drawn into the inside of the outer cylinder portion 9.

In the imaging device 1, the coupling protrusion portions 15 and 15 are inserted into and coupled to coupling holes of the adapter 2, respectively. When the coupling protrusion portions 15 and 15 are inserted into and coupled to the coupling holes of the adapter 2, respectively, and the adapter 2 is rotated with respect to the imaging device 1 to a predetermined position in a circumferential direction of the base body 4, the lock pin 16 is moved rearward by a biasing force of the spring and is inserted into the locked hole of the adapter 2, and the adapter 2 is mounted in a state of being locked to the imaging device 1.

On the other hand, when the lock release lever 17 is operated, the lock pin 16 is moved forward against the biasing force and is drawn out from the locked hole, and the lock by the lock pin 116 is released with respect to the adapter 2. By rotating the adapter 2 to a predetermined position in a circumferential direction of the base body 4 with respect to the imaging device 1, the coupling protrusion portions 15 and 15 can be drawn out from the coupling holes of the adapter 2, and the adapter 2 can be detached from the imaging device 1.

In the rear surface portion 9c of the outer cylinder portion 9, a battery cover 18 is disposed between the coupling protrusion portions 15 and 15 (see FIG. 5). In the imaging device 1, a battery accommodation portion (not shown) configured to accommodate a battery is formed inside the battery cover 18. By opening and closing the battery cover 18, mounting and removal of the battery (not shown) can be performed with respect to the battery accommodation portion.

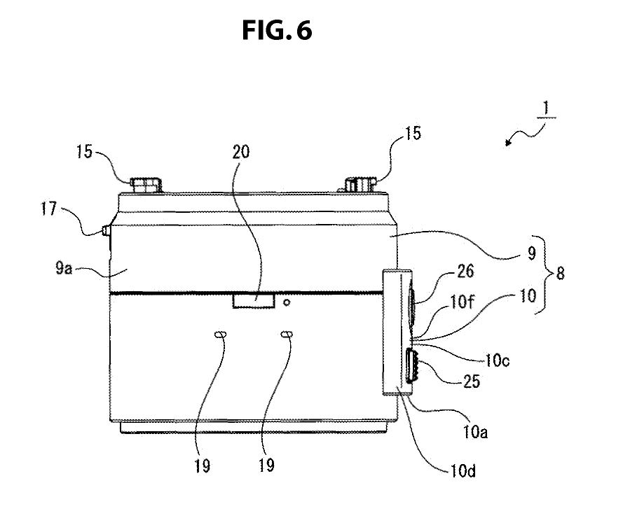

Microphones 19 and 19 and a power button 20 that are spaced apart horizontally are disposed at the upper end part of the cylindrical portion 9a of the outer cylinder portion 9 (see FIGS. 3 and 6). The microphones 19 and 19 are parts for inputting an external sound. The cylindrical portion 9a is a part constituting the outer case 8 and is positioned in the outermost periphery of the imaging device 1. Thus, by disposing the microphones 19 and 19 in the cylindrical portion 9a, the external sound is hardly blocked.

The power button 20 is disposed in a manner that the surface does not protrude outward from the outer periphery of the cylindrical portion 9a. Since the power button 20 does not protrude outward from the outer periphery of the cylindrical portion 9a, the erroneous operation of the power button 20 is prevented.

By operating the power button 20, power is turned on and off in the imaging device 1. When the power is turned on, the inner cylinder portions 11 and 11 are drawn forward with respect to the outer cylinder portion 9, and the photographing state is set (see FIG. 10). When the power is turned off, the inner cylinder portions 11 and 11 drawn forward are retracted rearward and accommodated in the inside of the outer cylinder portion 9, and the retracted state is set (see FIG. 3).

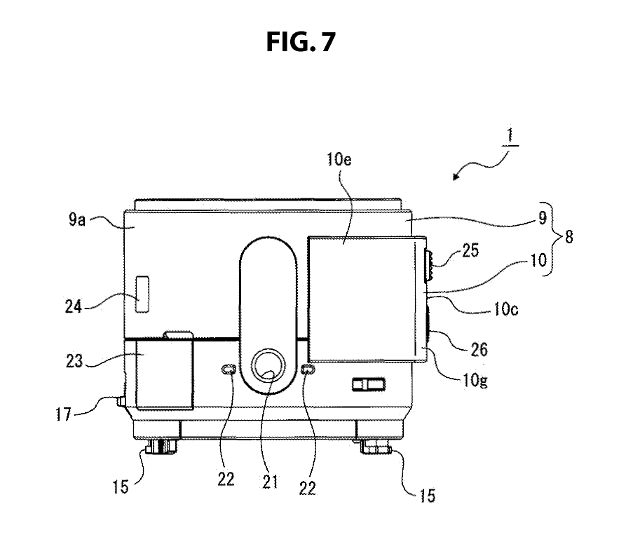

A hole 21 for a tripod is formed at a lower end part of the cylindrical portion 9a of the outer cylinder portion 9 (see FIG. 7). The hole 21 for the tripod is a hole for connecting the imaging device 1 to the tripod (not shown) at the time of photographing or the like.

In the lower end part of the cylindrical portion 9a of the outer cylinder portion 9, rolling regulation protrusions 22 and 22 are provided at the left side and right side of the hole 21 for the tripod, respectively (see FIGS. 4 and 7). The rolling regulation protrusions 22 and 22 have a function of reinforcing the function of the rolling prevention portion 10. The rolling regulation protrusions 22 and 22 regulate rolling of the imaging device 1 when the imaging device 1 is placed on the desk, table, or the like. Accordingly, the rolling regulation protrusions 22 and 22 can prevent damage or malfunction due to the falling or the like of the imaging device 1. In particular, the imaging device 1 is configured in a manner that the outer surface of the cylindrical portion 9a is a circumferential surface shape and the rolling regulation protrusions 22 and 22 are useful to prevent damage or malfunction due to the falling or the like.

A cover body 23 is disposed at a position near the lower end of the rear end part of the cylindrical portion 9a of the outer cylinder portion 9 (see FIGS. 7 and 9). In the imaging device 1, an external connection terminal, such as a universal serial bus (USB) (not shown), and a memory card slot are provided in the inside of the cover body 23. Therefore, by opening the cover body 17, connection to an external device and mounting of a memory card can be performed. Also, by the connection to the external device or the mounting of the memory card, an image or a video captured by the imaging device 1 can be recorded in the external device or the memory card.

A display unit 24 such as a liquid crystal panel is disposed at a right end part of the cylindrical portion 9a of the outer cylinder portion 9. The remaining amount of the battery or the insertion or non-insertion of the memory card into the memory card slot is displayed on the display unit 24.

Since the display unit 24 is disposed, the remaining amount of the battery, or the insertion or non-insertion of the memory card into the memory card slot can be checked from the outside of the imaging device 1, thus improving the usability of the imaging device 1.

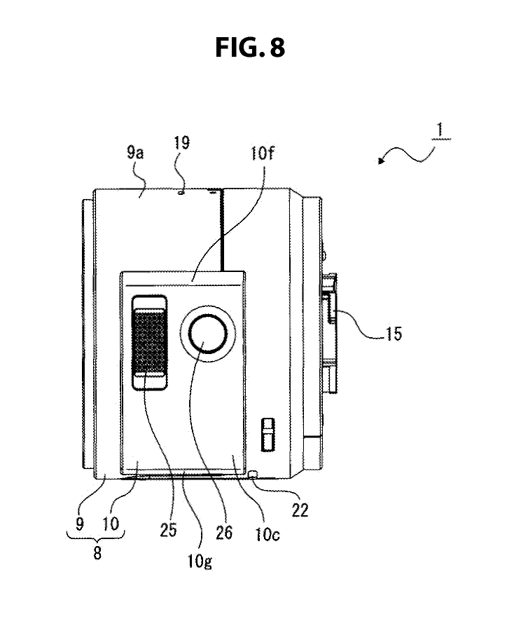

A zoom knob 25 for performing zooming and a shooting button 26 that functions as the shutter when capturing a still image are disposed at the side surface 10c of the rolling prevention portion 10 in a manner that the zoom knob 25 and the shooting button 26 are adjacently arranged in the front-rear direction (see FIGS. 3 and 8). A zoom between telephoto and wide angle is performed by operating the zoom knob 25, and a subject is photographed by operating the shooting button 26. Note that, the shooting button 26 also functions as a switch button for switching on and off of moving image shooting when shooting the moving image.

For example, the zoom knob 25 is operated by moving in a vertical direction. Since the zooming is performed by the operation of moving the zoom knob 25 in a predetermined direction, good operability can be ensured and the usability of the imaging device 1 can be improved.

Also, the zoom knob 25 may be configured in a manner that the zoom knob 25 is operated to move in a horizontal direction or an oblique direction.

Since the zoom knob 25 and the shooting button 26 are disposed close to each other, the user can easily perform a series of capturing operations in which a photographing operation is performed after performing a view angle adjustment by the zooming operation, and the usability of the imaging device 1 can be improved.

In the above example, the zoom knob 25 and the shooting button 26 are arranged in the front-rear direction. However, for example, the zoom knob 25 and the shooting button 26 may be adjacently arranged in the horizontal direction or the oblique direction.

Both of the zoom knob 25 and the shooting button 26 are disposed on the rolling prevention portion 10. Since both of the zoom knob 25 and the shooting button 26 are adjacently disposed on the rolling prevention portion 10, the rolling prevention portion 10 can be coupled with the cylindrical portion 9a of the outer cylinder portion 9 after the zoom knob 25 and the shooting button 26 are disposed on the rolling prevention portion 10. Accordingly, assembly of the imaging device 1 can be performed easily and effectively.

Also, for example, a function of performing autofocus by half-pressing and performing capturing by fully-pressing may be added to the shooting button 26. For example, the imaging device 1 may be used in a state of not being mounted on the display device 3, but the focusing operation is difficult because an image display unit does not exist in the imaging device 1. Therefore, if the autofocus is performed by half-pressing of the shooting button 26, it is possible to provide a user with an intuitively understandable operation.

Also, a sound output unit is provided in the imaging device 1. By outputting an electronic sound or the like from the sound output unit during the autofocus operation, the user recognizes that the operation has been performed, thus achieving the certainty of operation.

Furthermore, the zoom knob 25 and the shooting button 26 are disposed on the side surface 10c of the rolling prevention portion 10, and the zoom knob 25 and the shooting button 26 are positioned to be spaced apart from the microphones 19 and 19 provided at the upper end part of the cylindrical portion 9a. Therefore, a sound when the user operates the zoom knob 25 or the shooting button 26 is hardly input to the microphones 19 and 19 and it is possible to suppress a reduction in sound quality.

Moreover, since the power button 20 and the shooting button 26 are positioned on the upper part and the side part respectively, to be spaced apart in a circumferential direction of the imaging device 1, erroneous operation hardly occurs between the power on/off operation and the shooting operation.

In the imaging device 1, a wireless communication function is provided. The use of the wireless communication makes it possible to perform various operations, for example, an operation of displaying or storing an image or a video captured by the imaging device 1 to/in the display device 3, an operation of executing a photographing function of the imaging device 1 by performing an operation on the display device 3, and an operation of executing a zoom function of the imaging device 1 by performing an operation on the display device 3.

Specifically, for example, a near field communication (NFC) unit (NFC tag) performing an NFC is installed inside the cylindrical portion 9a of the outer cylinder portion 9. Non-contact communication is performed between the NFC communication unit and an NFC communication unit installed in the display device 3. In addition, for example, a wireless fidelity (Wi-Fi) communication unit for transmitting captured images is provided inside the cylindrical portion 9a of the outer cylinder portion 9. Wireless communication is performed between the Wi-Fi communication unit and a Wi-Fi communication unit installed in the display device 3.

In addition to be powered on by the operation performed on the power button 20, the imaging device 1 may be powered on by the NFC communication from the display device 3 side. For example, the imaging device 1 is powered on when the NFC communication is established. Also, in the imaging device 1, since the NFC communication function is displayed in the vicinity of the power button 20 of the upper end part or the like of the cylindrical portion 9a, the user easily checks whether or not the power on operation is performed and the usability of the imaging device 1 can be improved.

Also, since the NFC communication unit is disposed on the upper side in the inside of the cylindrical portion 9a, in a case where the tripod is attached to the hole 21 for the tripod and the imaging device 1 is used, the display device 3 easily approaches the NFC communication unit and it is advantageous to the non-contact communication.

Furthermore, the imaging device 1 may be used in a state of being placed on the placement surface such as a desk or a table, but in such a use state, it is usual that the user approaches the display device 3 to the imaging device 1 from above. Therefore, since the NFC communication unit is disposed on the upper side in the inside of the cylindrical portion 9a, the arrangement is suitable for the near field communication even in such a use state.

Also, the arrangement position of the NFC communication unit may be other than the upper side in the inside of the cylindrical portion 9a, but it is desirable that the NFC communication unit is disposed at a position close to the rear surface portion 9c of the outer cylinder portion 9. In a case where the NFC communication unit performing the near field communication is disposed close to the rear surface portion 9c side, as shown in FIGS. 1 and 2, when the imaging device 1 is used while being mounted on the display device 3 by the adapter 2, the NFC communication unit of the imaging device 1 is in a state of being always close to the NFC communication unit of the display device 3, and the polling may be always performed.

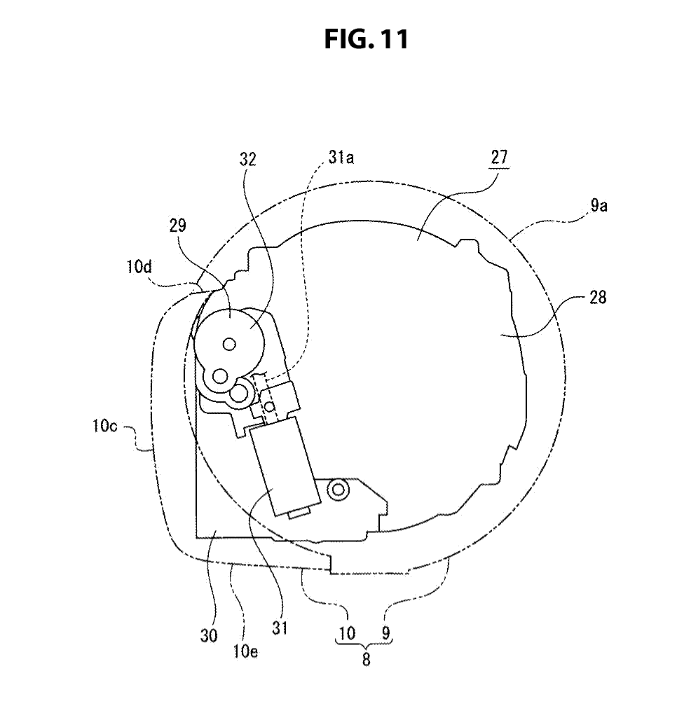

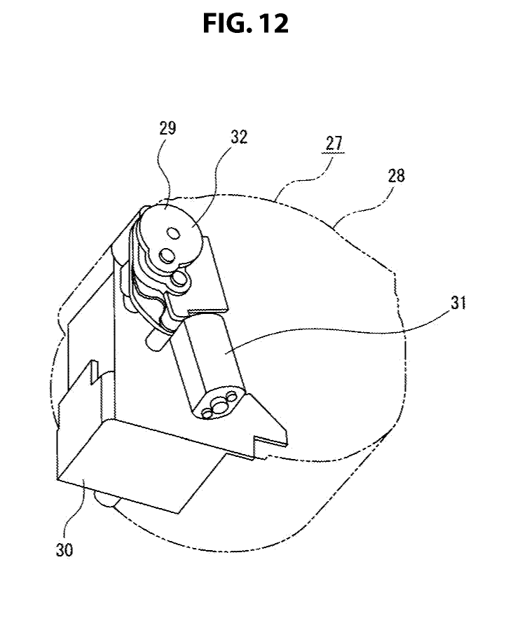

An imaging structure 27 is disposed inside the outer case 8 (see FIGS. 11 and 12).

The imaging structure 27 includes a lens barrel 28 in which the lens groups are disposed, a zoom drive mechanism 29 configured to perform zooming by moving a predetermined lens group (zoom lens) in the optical axis direction, and a focus drive mechanism 30 configured to perform focusing by moving a predetermined lens group (focus lens) in the optical axis direction.

The lens barrel 28 is disposed inside the outer cylinder portion 9 of the outer case 8.

The zoom drive mechanism 29 includes a zoom motor 31 and a gear box 32. Inside the gear box 32, a plurality of reduction gears (not shown) is disposed.

When the reduction gears are rotated by driving force of the zoom motor 31 in the zoom drive mechanism 29, the driving force of the zoom motor 31 is transmitted to the predetermined lens group (zoom lens) via the reduction gear, and the predetermined lens group is moved in the optical axis direction.

In the left end side inside the outer cylinder portion 9, the zoom drive mechanism 29 is disposed along an inner periphery of the cylindrical portion 9a and positioned at the rear side of the lens groups (see FIG. 11). In addition, the zoom drive mechanism 29 is disposed inside the cylindrical portion 9a in a state where a motor axis 31a is inclined vertically and horizontally.

As explained above, since the zoom drive mechanism 29 is disposed along the inner periphery of the cylindrical portion 9a, the zoom drive mechanism 29 is positioned at an outer periphery side inside the cylindrical portion 9a. Accordingly, an enough disposition space can be ensured for another structure to be disposed inside the cylindrical portion 9a, and the imaging device 1 can be downsized by using the disposition space effectively.

In addition, since the motor axis 31a of the zoom drive mechanism 29 is disposed inside the cylindrical portion 9a in the state where the motor axis 31a is inclined vertically and horizontally, a position where the zoom motor is disposed has a high degree of freedom. Accordingly, the imaging device 1 can be downsized more by using the disposition space effectively.

Moreover, since the zoom drive mechanism 29 is disposed at the rear side of the lens groups including the zoom lens, the zoom drive mechanism 29 is not positioned at an outer periphery side of the zoom lens. Accordingly, the external form of the cylindrical portion 9a is not enlarged, and the imaging device 1 can be downsized more.

The focus drive mechanism 30 includes a focus motor (not shown) and a plurality of transmission gear (not shown) to be rotated by driving force of the focus motor. When the transmission gears are rotated by the driving force of the focus motor in the zoom drive mechanism 30, the driving force of the focus motor is transmitted to the predetermined lens group (zoom lens) via the transmission gear, and the predetermined lens group is moved in the optical axis direction.

In front of the zoom drive mechanism 29, at least a part of the focus drive mechanism 30 is disposed inside the rolling prevention portion 10.

As explained above, since at least a part of the focus drive mechanism 30 is disposed inside the rolling prevention portion 10, the inside of the rolling prevention portion 10 having the function of preventing the imaging device 1 from rolling is effectively used as a disposition space of the focus drive mechanism 30.

Accordingly, a good functionality of the rolling prevention portion 10 is ensured and the imaging device 1 can be downsized.

### [Use Mode of Imaging Device]

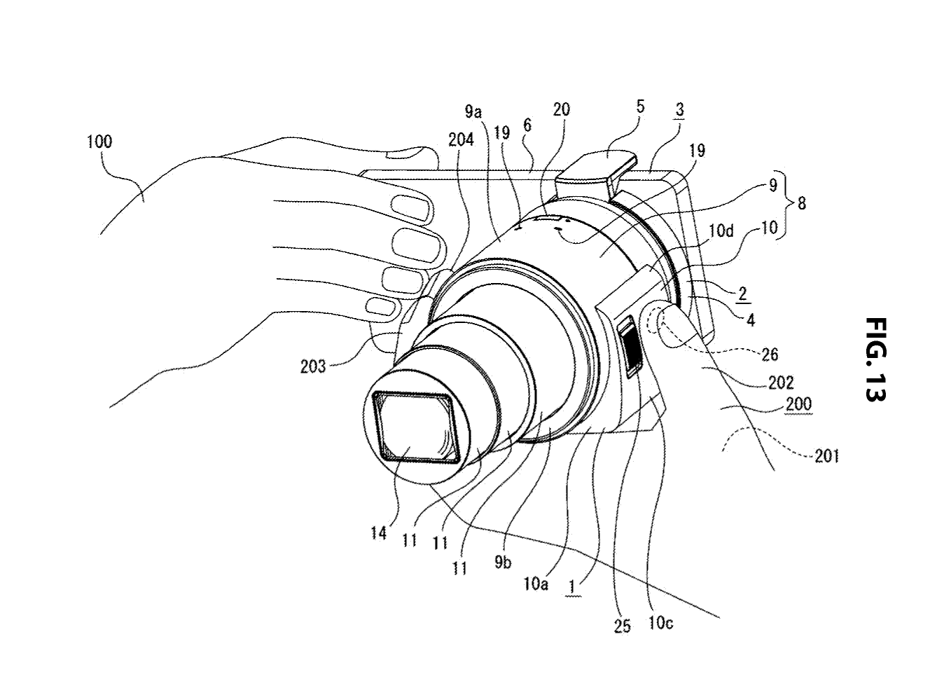

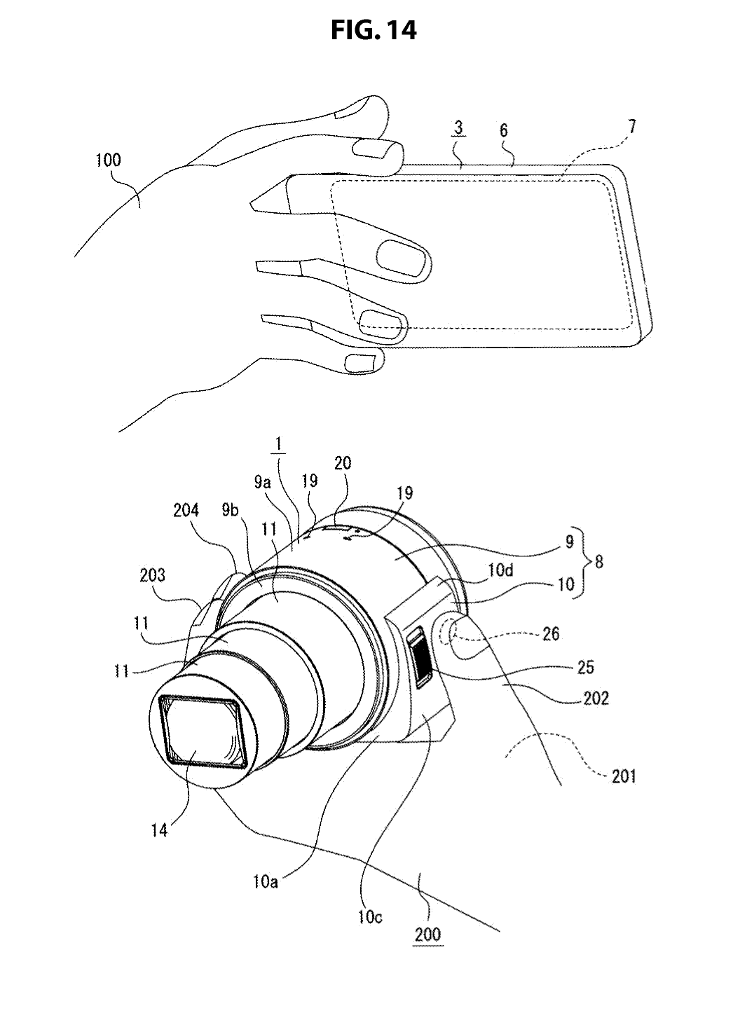

Next, a use mode of the imaging device 1 will be described (see FIGS. 13 and 14).

As described above, the adapter 2 mounted on the imaging device 1 is mounted on the display device 3, and the imaging device 1 is mounted on the display device 3 through the adapter 2. In such a state that the imaging device 1 is mounted on the display device 3 through the adapter 2, the photographing or the like can be performed using the imaging device 1.

At this time, for example, a photographer grasps the display device 3 with a right hand 100 and grasps the imaging device 1 with a left hand 200 (see FIG. 13). For example, the imaging device 1 is grasped with the left hand 200 so as to be lifted from the lower side, a palm 201 is put at a position over the left side surface from the bottom surface of the outer case 9, a thumb 202 is put on the side surface 10c of the first rolling prevention portion 10, and an index finger 203 and a middle finger 204 are put at a position over the right side surface from the bottom surface of the cylindrical portion 9a.

With regard to the imaging device 1, at least a part of the outer surface of the rolling prevention portion 10, or in other words, the side surface 10c and the bottom surface 10e are formed to have an extremely gentle outward convex curved shape. Accordingly, in the state where a palm 201 is put at a position over the left side surface from the bottom surface of the outer case 9 as described above, the palm 201 is put on the side surface 10c and the bottom surface 10e that have the curved shape. That is, good grasping property of the imaging device 1 can be ensured.

In addition, since the side surface 10c and the bottom surface 10e are formed to have the curved shape, the rolling prevention portion 10 can be formed to have a shape corresponding to the structure disposed inside the rolling prevention portion 10, and the imaging device 1 can be downsized.

As described above, with regard to the imaging device 1, the zoom knob 25 and the shooting button 26 that function as operation units are disposed on the rolling prevention portion 10. When the imaging device 1 is grasped by the left hand 200, the thumb 202 of the left hand is naturally put on the operation units.

Accordingly, when the imaging device 1 is grasped, a finger is naturally put on the rolling prevention portion 10 protruding from the outer cylinder portion 9, the good grasping property of the imaging device 1 can be ensured, and the good operability of the operation units can be ensured.

In addition, since the shooting button 26 for photographing a subject is provided as the operation unit disposed at the side surface 10c of the first rolling prevention portion 10, the shooting button 26 can be easily pressed by horizontally moving the finger put on the rolling prevention portion 10 protruding from the outer cylinder portion 9 and it is possible to ensure high operability with respect to the shooting button 26.

Furthermore, since the zoom knob 25 configured to change photographic magnification is provided as the operation unit disposed at the side surface 10c of the rolling prevention portion 10, the zoom knob 25 can be easily operated by moving the finger put on the rolling prevention portion 10 protruding from the outer cylinder portion 9 and it is possible to ensure high operability with respect to the zoom knob 25.

Furthermore, the zoom knob 25 is operated by the vertical movement, and the finger can be easily moved in the vertical direction in a state of being put on the rolling prevention portion 10. Therefore, since the zoom knob 25 is configured to be operated by the vertical movement, it is possible to ensure higher operability with respect to the zoom knob 25.

In the above, the use mode in which the imaging device 1 is mounted on the display device 3 through the adapter 2 has been described as an example, but the imaging device 1 can also be used in a state of not being mounted on the display device 3 (see FIG. 14). In this case, the setting is performed such that an image acquired by the imaging device 1 by approaching the NFC communication unit installed in the display device 3 to the NFC communication unit (NFC tag) provided in the imaging device 1 is displayed on the display panel 7 of the display device 3, and the capturing of the image or video acquired by the imaging device 1 can be performed by operating a predetermined operation unit of the display panel 7 (touch panel) while checking the image displayed on the display panel 7.

At this time, a desired image may be acquired by grasping the imaging device 1 with the hand not grasping the display device 3, for example, the left hand 200, and an image may also be acquired when the imaging device 1 is in a stationary state. In the use mode of such a stationary state, the rolling of the imaging device 1 with respect to the placement surface such as the desk or the table can be prevented by the rolling prevention portion 10 and it is possible to ensure the stable placement state of the imaging device 1 and improve the image quality of the acquired image. In the use mode of the stationary state, the stable placement state of the imaging device 1 can be ensured by the rolling regulation protrusions 22 and 22 that are provided at the lower end part of the outer cylinder portion 9.

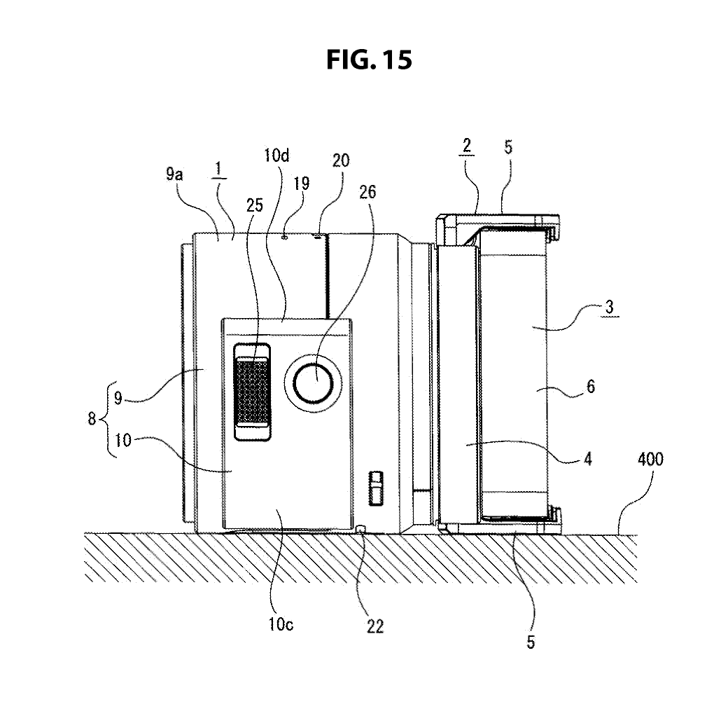

Also, in a state in which the imaging device 1 is mounted on the display device 3 through the adapter 2, the photographing or the like can be performed in a stationary state in which the imaging device 1 is placed on the placement surface such as the desk or the table (see FIG. 15). In the use mode of such a stationary state, since the imaging device 1 and the display device 3 are placed on the placement surface 400 at positions spaced apart in the front-rear direction and a linearly formed inferior border of the display device 3 is placed on the placement surface 400, it is possible to ensure the stable placement state of the imaging device 1 and improve the image quality of the acquired image.

Also, both operations of capturing the image or the video in the carrying state (grasping state) of the imaging device 1 and the stationary state are similar to each other, the imaging device 1 and the display device 3 communicate with each other by wireless, and the image or the video captured by the imaging device 1 is displayed on the display panel 7 of the display device 3. A photographer can check a screen displayed on the display panel 7 and capture the image or video acquired by the imaging device 1 by operating the shooting button 26 of the imaging device 1 or operating a predetermined operation unit of the display panel 7 that is the touch panel.

### [Embodiment of Imaging Device]

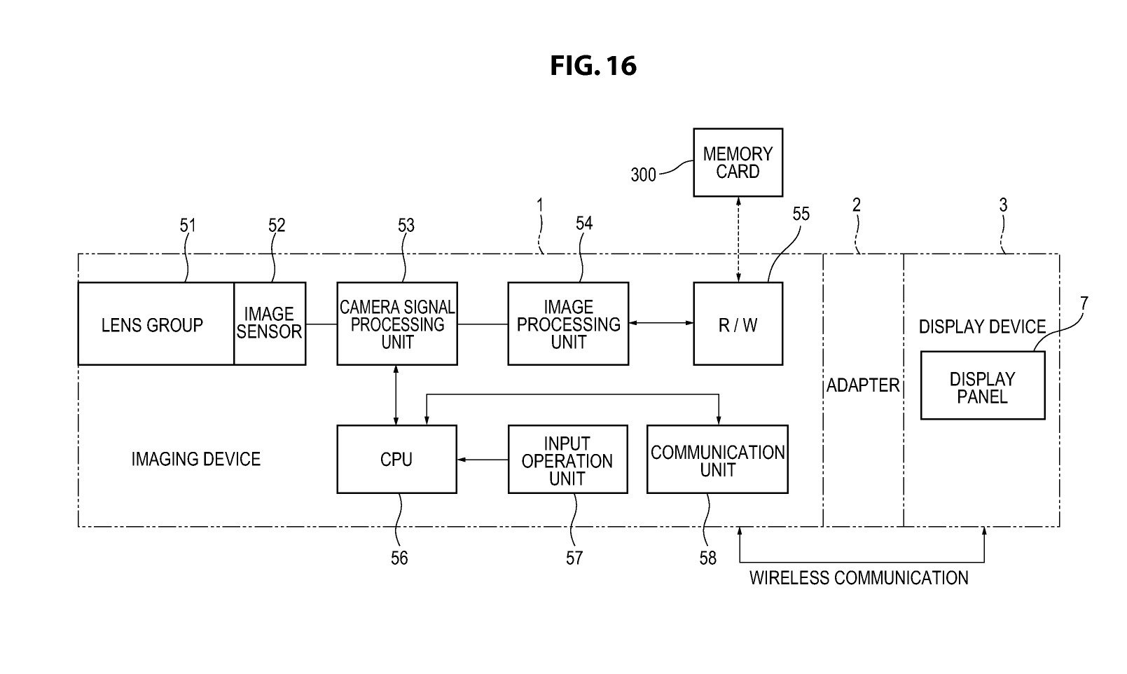

The following shows a block diagram of an imaging device according to an embodiment of the present technology (see FIG. 16).

The imaging device 1 includes lens groups 51 that are adjacently arranged in the optical axis direction, an image sensor 52 configured to photoelectrically convert light captured through the lens groups 51, a camera signal processing unit 53 configured to perform signal processing such as analog-to-digital conversion of a captured image signal, and an image processing unit 54 configured to perform recording and reproduction processing of the image signal. Also, the imaging device 1 includes a reader/writer (R/W) 55 configured to write and read the image signal to/from a memory card 300, a central processing unit (CPU) 56 configured to control the entire imaging device 1, input operation units 57, 57, . . . (zoom knob 25, shooting button 26, etc.) such as various switches configured to allow a user to perform necessary operations, and a communication unit 58.

The camera signal processing unit 53 performs a variety of signal processing, such as conversion of a signal output from the image sensor 52 into a digital signal, noise removal, image quality correction, or conversion into luminance and color difference signals.

The image processing unit 54 performs compression encoding and expansion decoding processing of the image signal, based on a predetermined image data format, or conversion processing of data specifications such as a resolution.

The R/W 55 writes the image data encoded by the image processing unit 54 to the memory card 300 and read the image data recorded in the memory card 300.

The CPU 56 functions as a control processing unit configured to control the respective units provided in the imaging device 1 and controls the respective units based on an instruction input signal from the input operation units 57, 57, . . . .

Also, the CPU 56 can transmit and receive various data or control information to/from the display device 3 through the wireless communication by the communication unit 58 including the NFC communication unit or the WiFi communication unit.

The input operation units 57, 57, . . . output the instruction input signal corresponding to the operation of the user to the CPU 56.

The memory card 300 is, for example, semiconductor memory that can be detachably attached to the memory card slot connected to the R/W 55.

Next, operation of the control device 1 is explained.

When the photographing operation is performed by the instruction input signal from the input operation units 57, 57, . . . , the captured image signal is output from the camera signal processing unit 53 to the image processing unit 54, undergoes compression encoding processing, and is converted into digital data of a predetermined data format. The converted data is output to the R/W 55 and is written to the memory card 300. Also, the converted data is transferred to the display device 3 by the wireless communication and is output to the display panel 7, or may be written to a storage unit of the display device 3.

In a case where the image data recorded in the memory card 300 is reproduced, the predetermined image data is read from the memory card 300 by the R/W 55 according to the operation performed on the input operation unit 57, 57, . . . . After the expansion decoding processing is performed on the read predetermined image data by the image processing unit 54, a reproduced image signal is transferred to the display device 3 by the wireless communication and is output to the display panel 7. Thus, an image to be reproduced is displayed.

### [Conclusion]

As described above, with regard to the imaging device 1, the rolling prevention portion 10 is provided at the lower surface side of the cylindrical portion 9a, and the central portion Mb of the rolling prevention portion 10 in a horizontal direction is positioned off to left or right of the central portion Ma of the cylindrical portion 9a in the horizontal direction.

Accordingly, the rolling prevention portion 10 prevents the imaging device 1 from rolling, and photographing can be performed by grasping the rolling prevention portion 10 during photographing. Accordingly, good storage property during unuse and good grasping property during photographing are ensured, and it is possible to improve the usability of the imaging device 1.

In addition, since the central portion Mb of the rolling prevention portion 10 in a horizontal direction is positioned off to left of the central portion Ma of the cylindrical portion 9a in the horizontal direction, and the photographer tends to perform photograph with the left hand 200 grasping the imaging device 1, the thumb 202 of the left hand 200 is put on the rolling prevention portion 10, and the grasping property of the imaging device 1 can be improved.

It should be understood by those skilled in the art that various modifications, combinations, sub-combinations and alterations may occur depending on design requirements and other factors insofar as they are within the scope of the appended claims or the equivalents thereof.

### [Present Technology]

Additionally, the present technology may also be configured as below.

(1) An imaging device including:

an outer case in which a photographic lens is disposed inside,

wherein the outer case includes a cylindrical portion in which an external shape of a cross-section perpendicular to an optical axis of the photographic lens is formed into a substantially circular shape, and a rolling prevention portion provided to protrude outside the cylindrical portion in a direction perpendicular to the optical axis,

wherein the rolling prevention portion is provided on a lower surface side of the cylindrical portion, and

wherein a central portion of the rolling prevention portion in a horizontal direction is positioned off to left or right of a central portion of the cylindrical portion in the horizontal direction.

(2) The imaging device according to (1),

wherein the central portion of the rolling prevention portion in the horizontal direction is positioned off to the left of the cylindrical portion.

(3) The imaging device according to (1) or (2),

wherein an operation unit is disposed on the rolling prevention portion.

(4) The imaging device according to (3),

wherein a shooting button configured to capture a subject is provided as the operation unit.

(5) The imaging device according to (3),

wherein a zoom knob configured to change photographic magnification is provided as the operation unit.

(6) The imaging device according to (5),

wherein the zoom knob is operated by vertical movement.

(7) The imaging device according to any one of (1) to (6),

wherein at least a part of a drive mechanism including a drive motor is disposed inside the rolling prevention portion.

(8) The imaging device according to any one of (1) to (7),

wherein at least a part of an outer surface of the rolling prevention portion has a curved shape.

(9) The imaging device according to any one of (1) to (8),

wherein the cylindrical portion and the rolling prevention portion are formed of different members, and

wherein the cylindrical portion and the rolling prevention portion are coupled.

(10) The imaging device according to any one of (1) to (9),

wherein a surface of the cylindrical portion and a surface of the rolling prevention portion have different colors.

(11) The imaging device according to any one of (1) to (10),

wherein the rolling prevention portion has a glossy front surface.

(12) The imaging device according to any one of (1) to (11),

wherein a zoom drive mechanism is disposed inside the cylindrical portion, the zoom drive mechanism including a zoom lens and a zoom motor configured to move the zoom lens in the optical axis direction so as to change photographic magnification, and

wherein the zoom drive mechanism is disposed along an inner periphery of the cylindrical portion.

(13) The imaging device according to (12),

wherein the zoom motor is disposed in a state where a motor axis of the zoom motor is inclined vertically and horizontally.

(14) The imaging device according to (12) or (13),

wherein the zoom drive mechanism is disposed on a rear side of the zoom lens.

What is claimed is:

1. An imaging device comprising:
an outer case in which a photographic lens is disposed inside,
wherein the outer case includes a cylindrical portion in which an external shape of a cross-section perpendicular to an optical axis of the photographic lens is formed into a substantially circular shape, and a rolling prevention portion provided to protrude outside the cylindrical portion in a direction perpendicular to the optical axis,
wherein the rolling prevention portion is provided on a lower surface side of the cylindrical portion, and
wherein a central portion of the rolling prevention portion in a horizontal direction is positioned off to left or right of a central portion of the cylindrical portion in the horizontal direction.

2. The imaging device according to claim 1,
wherein the central portion of the rolling prevention portion in the horizontal direction is positioned off to the left of the cylindrical portion.

3. The imaging device according to claim 1,
wherein an operation unit is disposed on the rolling prevention portion.

4. The imaging device according to claim 3,
wherein a shooting button configured to capture a subject is provided as the operation unit.

5. The imaging device according to claim 3,
wherein a zoom knob configured to change photographic magnification is provided as the operation unit.

6. The imaging device according to claim 5,
wherein the zoom knob is operated by vertical movement.

7. The imaging device according to claim 1,
wherein at least a part of a drive mechanism including a drive motor is disposed inside the rolling prevention portion.

8. The imaging device according to claim 1,
wherein at least a part of an outer surface of the rolling prevention portion has a curved shape.

9. The imaging device according to claim 1,
wherein the cylindrical portion and the rolling prevention portion are formed of different members, and
wherein the cylindrical portion and the rolling prevention portion are coupled.

10. The imaging device according to claim 1,
wherein a surface of the cylindrical portion and a surface of the rolling prevention portion have different colors.

11. The imaging device according to claim 1,
wherein the rolling prevention portion has a glossy front surface.

12. The imaging device according to claim 1,
wherein a zoom drive mechanism is disposed inside the cylindrical portion, the zoom drive mechanism including a zoom lens and a zoom motor configured to move the zoom lens in the optical axis direction so as to change photographic magnification, and
wherein the zoom drive mechanism is disposed along an inner periphery of the cylindrical portion.

13. The imaging device according to claim 12,
wherein the zoom motor is disposed in a state where a motor axis of the zoom motor is inclined vertically and horizontally.

14. The imaging device according to claim 12,
wherein the zoom drive mechanism is disposed on a rear side of the zoom lens.
